(19) United States
(12) Patent Application Publication
(10) Pub. No.: US 2009/0043812 A1
(43) Pub. Date: Feb. 12, 2009

(54) INFORMATION ASSESSMENT ASSOCIATE FOR CHECKPOINT OPERATIONS

(75) Inventor: Debra A. Rigdon, Kent, WA (US)

Correspondence Address: NovaTech IP Law, 1001 Ave. Pico, Suite C500, San Clemente, CA, 92673, US

(73) Assignee: THE BOEING COMPANY, Seal Beach, CA (US)

(21) Appl. No.: 11/766,828

(22) Filed: Aug. 6, 2007

(51) Int. Cl. G06F 7/00; G06F 15/18; G06F 17/30

(52) U.S. Cl. 707/104.1; 706/21; 707/E17.032; 707/E17.044

(57) ABSTRACT

In accordance with an embodiment, a method includes receiving, by a computing environment, one or more answers to one or more questions from an assessing agent at a security checkpoint. The agent interrogates a party attempting to pass through the security checkpoint with questions. The questions are provided to the agent in real time by the computing environment. The party being interrogated providing the answers. Subsequent answers are dynamically correlated in real time with previously received answers, and with either or both of real time and/or stored security data until a security status is established. A security status for the party is determined in real time based on the results of the correlating. The security status of the party is communicated to the assessing agent in real time.

### FIELD

Embodiments disclosed relate to the field of data processing, in particular, to security methods, apparatuses and articles associated with or related to operating security checkpoints.

### BACKGROUND

Advances in storage and computing technology have resulted in devices with higher capacity storage and faster computing times in ever smaller forms. This, combined with faster communication between system components and networks, allows ever greater opportunities to store, access and analyze electronic data. This allows an application operating at one locale to be able to draw on data from multiple remote locations, including real-time data gathered at the remote locations.

Currently, security checkpoints, such as army checkpoints, are typically manned by personnel that follow a procedure laid out in a field manual. Checkpoint personnel often use outdated or incomplete information at best, only having access to isolated databases via other personnel; they are often reliant upon remotely located intelligence officers accessing data, e.g., passport databases and vehicle identification databases. The security checkpoint personnel collect data and evaluate the situation using a set of static rules laid out in the Army field manual. The questions being asked follow a predictable pattern. Very often, the data is collected using a paper method, resultantly not all answers are collected and thus valuable intelligence may be lost.

Most often, the data is collected and relayed back to a central informational storage at a later date. It is then possible to carry out analysis on all the information gathered, but this is not done in real time. Important information which could be useful to Checkpoint Agents is either lost or not relayed to the agent in a timely manner, valuable information is not used or possibly lost and this benefits hostile individuals and organizations.

Very often, at best the Agents manning a checkpoint are able to have limited communication with an intelligence officer located in a more central location, allowing the intelligence officers to work with several geographically distributed security checkpoints. The main purpose being to verify information rather than construct new questions from the previously received answers and verified information. Frequently, individuals and items of interest will pass through different security checkpoints at different times creating unknown risk. The safety of the security personnel is always at risk as unknown hostile parties may be passing through with the intent of causing maximum damage to either the checkpoint and its personnel, or an asset on the other side of the checkpoint. Due to safety concerns Agents at the checkpoint have to take considerable care, and this can result in delays for nonhostile parties passing through the checkpoint. This in turn leads to frustrations for the local population who cross the security checkpoint for completely legitimate reasons and pose no hostile threat. This in itself can lead to resentment towards the checkpoint personnel by the local population, potentially fueling terrorist or criminal activity. Further, intelligence information gathered are seldom cross-checked and/or verified in real time.

Other areas that employ security checkpoints, e.g., airports, border crossings etc., use a similar method to ascertain the status of parties trying to pass through them. The Information is not collected and correlated in real time, which would allow for new questions to be generated in real time from the valuable subset of already-gathered information, allowing a more adaptive and in-depth interview to be carried out, and possibly hostile parties or criminals to be identified. The security checkpoints are not as secure and as effective as security checkpoints could be, compromising legitimate parties passing through the checkpoints, allowing hostile parties to pass, and criminal activity to occur.

### SUMMARY

Embodiments of the present disclosure solve the problem of using more available information sources and intelligent systems in real time to ascertain the status of a party passing through a checkpoint. For the purposes of this disclosure, the phrase “in real time” includes a rapid or immediate interactivity, where inputs are received, analyzed, and a result is determined in a period of seconds or minutes, in contrast to a different process where information may be stored and analyzed later. This may be achieved by generating questions in real time to be asked of an individual or party attempting to pass through a security checkpoint, correlating the information gained from the questions, and combining the information with current and historical data to further compile additional questions for the party being processed. This process may be repeated with further questions driving to gain enough information to determine whether the party's status is safe or potentially hostile, and whether the party should be detained or contained. Further, the vehicle and its contents along with any items being hand carried are also evaluated and correlated to determine whether they should increase the level of suspicion of the person. Once the status is determined this information may be passed to the agent allowing appropriate action to be carried out. This may allow the personnel to take reduced risk when questioning an individual or party as they attempt to pass through the security checkpoint. As every transaction may be recorded, questions asked and responses received may be correlated with other available data and known outcome; this may allow the transaction to also be used for training, improving the system, and following up with agent performance. In one embodiment, a method includes receiving information from an agent, then correlating the information gathered by the agent. From the gathered information and any other information available to the agent, a security status may be determined. The determined security status may then be indicated to an agent. In another embodiment, an apparatus may comprise a processor, and logic operated by the processor which is adapted to provide questions to an agent. The apparatus may then receive in real time, answers to the provided questions by an agent at a security checkpoint, where the agent is interrogating a party. The questions may be provided to the agent in real time by the apparatus, and the answers being obtained from the party being input into the apparatus. The apparatus may dynamically correlate the received answers with either or both of real time data and/or stored security data. The apparatus may determine a security status of the party based on results of the correlated answers and indicate to the agent the determined security status of the party.

### BRIEF DESCRIPTION OF THE DRAWINGS

Embodiments of the disclosure will be readily understood by the following detailed description in conjunction with the accompanying drawings. Embodiments of the disclosure are illustrated by way of example and not by way of limitation in the figures of the accompanying drawings.

FIG. 1 depicts an overview of the computing environment in accordance with various embodiments of the present disclosure.

FIG. 2 depicts a simplified Plan Goal Graph (PGG) used in accordance with various embodiments of the present disclosure.

FIG. 3 depicts a simplified Concept Node Graph (CNG) used in accordance with various embodiments of the present disclosure.

FIG. 4 depicts a flowchart view of selected operations of the methods used in accordance with various embodiments of the present disclosure.

FIG. 5 depicts an exemplary computing device capable of performing the operations of various embodiments of the present disclosure.

### DETAILED DESCRIPTION

Illustrative embodiments of the present disclosure include, but are not limited to, methods, apparatuses and articles of manufacture for determining the status of a party attempting to pass through a security checkpoint, using an Information Assessment Associate for Checkpoint Operations (IA2-CO). The Information Assessment Associate for Checkpoint Operations may use intelligent systems, databases, historical data, current data, data specific to the location of the security checkpoint, trend data and current data coming from one or more other checkpoints which may occur in real time. This approach to security checkpoints, using the Information Assessment Associate for Checkpoint Operations allows for a more effective and efficient security checkpoint as well as providing a safer environment for security checkpoint personnel. For the purposes of the description the term party may be or may include, but may not be limited to include, a person, a group of people, a vehicle, any materials being transported, either in the vehicle or by individuals, cargo, or components of items.

The description may use perspective-based descriptions such as up/down, back/front, and top/bottom. Such descriptions are merely used to facilitate the discussion and are not intended to restrict the application of the embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B).” For the purposes of the description, a phrase in the form “at least one of A, B, and C” means “(A), (B), (C), (A and B), (A and C), (B and C), or (A, B and C).” For the purposes of the description, a phrase in the form “(A)B” means “(B) or (AB),” that is, A is an optional element.

The description may use the phrases, “various embodiments,” “in an embodiment,” or “in embodiments,” which may each refer to one or more of the same or different embodiments. Furthermore, the terms “comprising,” “including,” “having,” and the like, as used with respect to embodiments as described in the present disclosure, are synonymous. Various operations may be described as multiple discrete operations in turn, in a manner that may be helpful in understanding various embodiments; however, the order of description should not be construed to imply that these operations are order dependent.

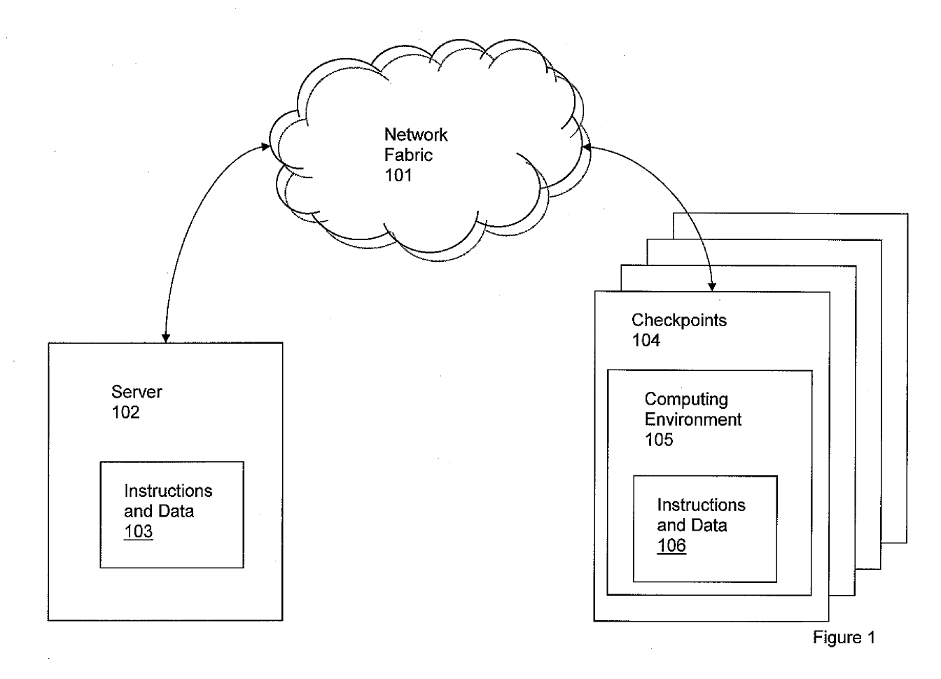

FIG. 1 depicts an overview of various disclosed embodiments. The Figure illustrates components that may make up an Information Assessment Associate for Checkpoint Operations. FIG. 1 shows an embodiment of a Checkpoint 104 that is made up of a Computing Environment 105 that has access to local Instructions and Data 106 and may be connected to a Network Fabric 101. The Network Fabric 101 may allow the Computing Environment 105 to communicate with a Server 102 which has access to non local Instructions and Data 103 as well as local Instructions and Data; allowing the Computing Environment 105 to access the nonlocal Instructions and Data 103 that may be accessible via the Server 102. Local instructions and data 106 in this embodiment are instructions and data that are always accessible by the Computing Environment 105. While the Computing Environment 105 is functioning it may access the local Instructions and Data 106. Multiple checkpoints may operate in parallel, communicating with one or more servers, over the same or different Network Fabric 101.

A Checkpoint 104 may be any controlled access point that is manned by personnel or automated with devices capable of barring entry, and restraining and detaining an individual or party trying to pass through the Checkpoint 104. The Checkpoint 104 may be a permanent structure in a fixed location, for instance a border crossing Checkpoint; a temporary structured Checkpoint 104, a temporary mobile Checkpoint 104 for instance temporarily securing access to a city, an area or a building within a conflict zone. The Checkpoint 104 may be located in different situations in various locations including Army checkpoints, border crossings, airports, ports of entry, container terminals, or roadblock checkpoints. The parties attempting to pass through the Checkpoint 104 may include nonhostile parties, hostile parties, terrorists, criminals, smugglers, vehicles, containers carrying freight, or known wanted parties.

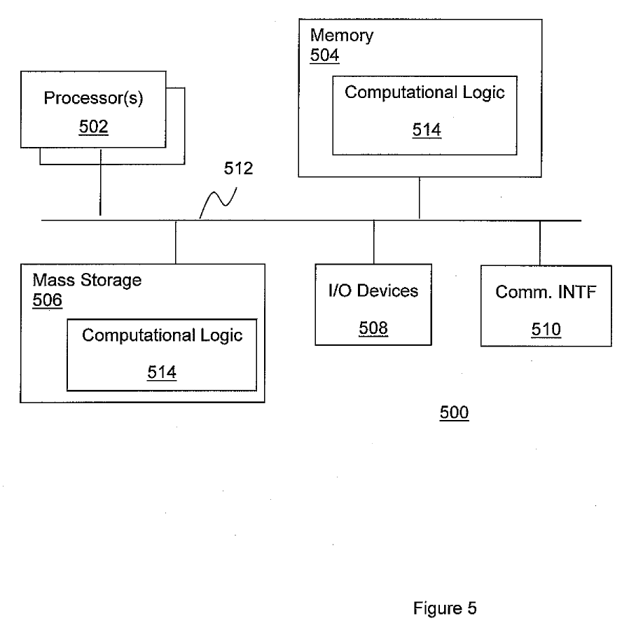

In various embodiments, the Server 102 and/or Computing Environment 105 of a Checkpoint 104 may comprise any single- or multi-processor or processor core central processing unit (CPU) based computing system. The Server 102 and/or Computing Environment 105 may be a personal computer (PC), a workstation, a server, handheld computing device, mobile computing device, remote terminal device, wearable voice activated computing device, a router, a mainframe, a modular computer within a blade server or high-density server, a personal digital assistant (PDA), an entertainment center, a set-top box, a media player, or a mobile device. The Server 102 and/or Computing Environment 105 may be capable of operating a plurality of operating systems (OS) in a plurality of virtual machines using virtualization technologies. The Server 102 and/or Computing Environment 105 may be embodied by an exemplary single-/multi-processor or processor core device, illustrated by FIG. 5, and is described in greater detail below.

The Computing Environment 105 and Server 102 may be connected to a Network Fabric 101, which may be any sort of networking fabric known in the art, such as one or more of a local area network (LAN), a wide area network (WAN), and the Internet. The Computing Environment 105 and Server 102 may communicate via a Network Fabric 101 and may further use any communication protocol known in the art, such as the Hypertext Transfer Protocol (HTTP), and any transport protocol known in the art, such as the Transmission Control Protocol/Internet Protocol (TCP/IP) suite of protocols.

In various embodiments the Computing Environment 105 may work in either a stand-alone mode, completely detached from any data Network Fabric 101, in periodic contact with a data Network Fabric 101 or continually attached to a data Network Fabric 101. One or more of a plurality of Checkpoints 104 may be connected to a Network Fabric 101 allowing the plurality of Checkpoints 104 to communicate with other Checkpoints 104. The communication between Checkpoints 104 may allow for correlation of data between Checkpoints 104 in real time and time-correlated information, where parties heading through Checkpoints 104 at the same time may be evaluated together in real time to determine their status.

The Checkpoint Computing Environment 105 in this embodiment contains Instructions and Data 106; these Instructions and Data 106 may be used by the Computing Environment 105 to carry out the operations of the embodiment to determine the status (e.g. friendly, unfriendly, hostile or nonhostile) of a party passing through the Checkpoint 104. Depending on the operating mode of the Computing Environment 105, the Computing Environment 105 may share, update, upload, download or compute with data from one or more of the plurality of networked Checkpoints 104. The Computing Environment 105 may also attach to a Server 102 using a Network Fabric 101, the Server 102 being able to access Instructions and Data 103, these Instructions and Data 103 may also be used by the Computing Environment 105 in some embodiments to augment or in lieu of the local Instructions and Data 106 to determine the status of a party attempting to pass through a security Checkpoint 104. The Instructions and Data 103 may comprise of databases, historical data, current data, data specific to the location of the security checkpoint, trend data and current data coming from one or more other checkpoints through the Network Fabric 101, which may occur in real time.

Using the available data and responses from previous questions the Computing Environment 105 may generate challenge questions to ask an individual or party, the questions may be generated using artificial intelligence, question databases, predictive analysis, inductive reasoning, Bayesian reasoning, iterative methods, or probability analysis. The questions may be generated in real time and provided to the Agent at the Checkpoint by the Computing Environment's 105 output device; this may be effectuated through a GUI and/or audible means where the questions are provided visually and/or aurally to the Agent through a display device and an earpiece, respectively. The questions may be provided to an autonomous agent, such as an unmanned gate with a voice activated computer terminal, the questions may be posed in one or more languages.

In one embodiment the Computing Environment 105 is configured to be able to determine the status of a party from as many data sources as there are available to the Computing Environment 105. The Computing Environment 105 operates in one of at least two modes, a networked mode and a stand-alone mode. The Computing Environment 105 typically operates in the networked mode when networking communication is available and in the stand-alone mode when networking communication is not available. If the Computing Environment 105 goes from a networked mode to a stand-alone mode due to circumstances outside the control of the Computing Environment 105, the device may continue to operate and determine the status of a party attempting to cross the security Checkpoint 104. This determining may be in real time saving the information for a subsequent time when the data may be uploaded to a central Server 102 through a Network Fabric 101, when networking communication becomes available again.

The Computing Environment 105 may use the responses gathered from an individual and available data to correlate in real time using intelligent systems, artificial intelligence, predictive analysis, inductive reasoning, Bayesian reasoning, iterative methods, or probability calculations. The focus of the questions is to evaluate the intent of the party via determination of suspicion factors (is the party acting suspiciously, are there aspects of the party's background that raise suspicion, etc.), whether the individual has the means, motive and opportunity to perform a hostile, terrorist or criminal act. Evaluation of the party may include voice stress analysis or biometric sampling. Whether the party is transporting items that may be suspicious and lend themselves to a criminal or terrorist act when used alone or when combined with other components being transported at different times and locations. Suspicion may be raised when combining historical data with real time current data being collected as a party attempts to pass through the security checkpoint.

The Computing Environment 105 may then indicate to the agent operating at the Checkpoint, the status of the party by the results determined from correlating the party's responses with available real time and/or pregathered data. The determining of the security status may be further based on an algorithmic expression using suspicion, means, motive, and/or opportunity.

The status in this embodiment may be indicated to the agent using the GUI of the output device of the Computing Environment 105; in other embodiments it may be an audible output through an earpiece device, using a computerized voice output device. The status may either be known or unknown, that is the status of the party has been correlated by the Computing Environment 105 and the Computing Environment 105 has a status of safe, hostile, detain, contain, terrorist, criminal or smuggling for the party; or the status of the party is still unknown to the Computing Environment 105. In this case the Computing Environment 105 may continue to generate questions for the agent. The Computing Environment 105 may continue this cycle of generating questions and correlating responses with known data until a status for the party is ascertained. An alert may be generated to notify personnel at the checkpoint or to notify reinforcements. The Computing Environment 105 may record every question, answer, and correlation; allowing the activities at the Checkpoint 104 to be evaluated for improvements, performance reviews of agents, and reenactment of prior events requiring scrutiny to allow the events to be analyzed.

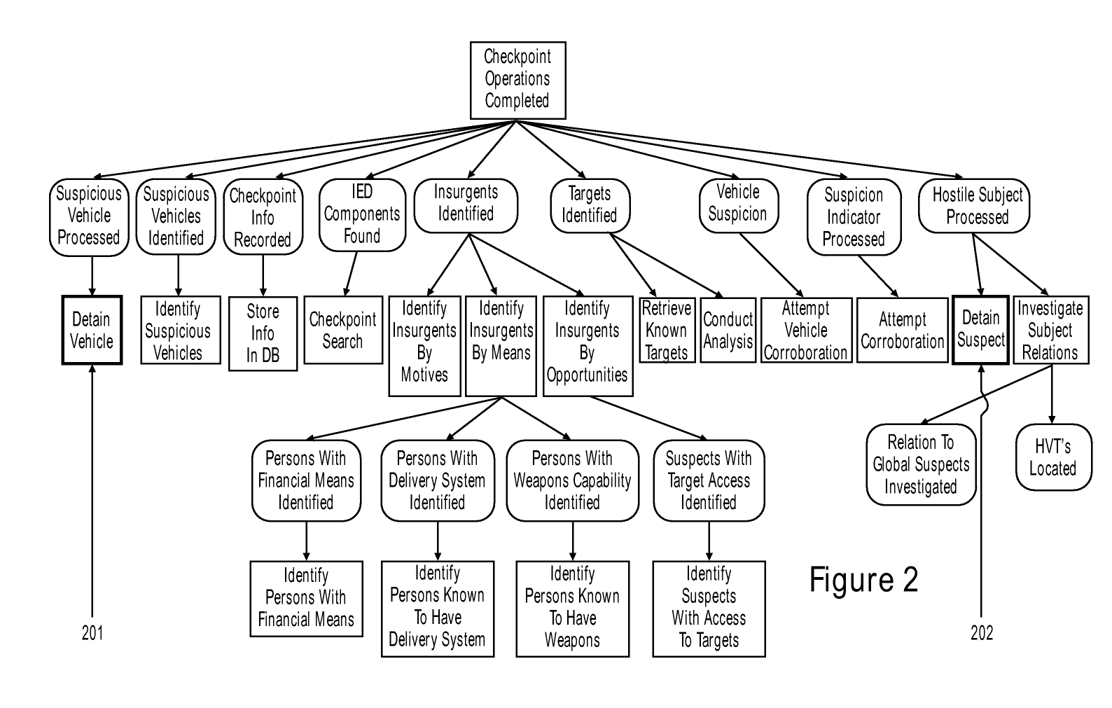

FIG. 2 Depicts a simplified Plan Goal Graph (PGG) used in accordance with various embodiments. A PGG is a schematic of the plans and goals which describe the operations which may be carried out using the Computing Environment 105, and how these operations are related. The rectangular boxes are the plans, and the ovals (or rounded rectangles) are the goals. Goals express a state of the system which the Computing Environment 105 may attempt to reach; all child goals may be satisfied before a parent plan may be satisfied. A plan may be a way or means of satisfying a goal, and frequently involves actions. Not shown is the control logic which may be required to make the PGG function (such as event monitors), along with all the actions (e.g., queries to database, messages to the agents to ask questions, etc.). FIG. 2 is specific to an example case of Checkpoints in a military context, where the emphasis is on people (driver and passengers), vehicles and potential IEDs (Improvised Explosive Devices) components which might be smuggled across the checkpoint. The key outcomes are “Detain Vehicle” 201 and “Detain Suspect” 202 concluded from sufficient evidence being accrued, either a person or a vehicle may be detained for further investigation.

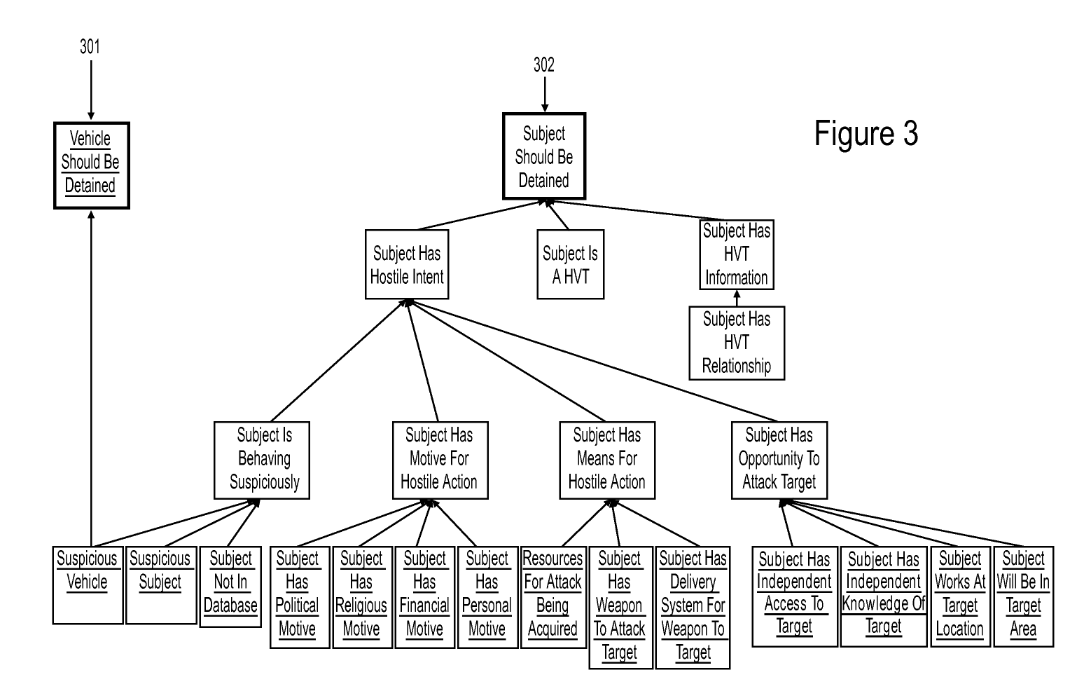

FIG. 3 depicts a simplified Concept Node Graph (CNG) used in accordance with various embodiments. FIG. 3 is the top levels of the CNG which may be used in the Computing Environment 105, and provides an abstract view of possible relationships that may lead to a party being detained. When the embodiment is active, the CNG may be updated to show the current state of the embodiment. Some of the details have been removed so not to obscure the key relationships between the PGG and the CNG, specifically how suspicion, means, motive and opportunity are tied together, with the CNG containing the current level of belief that a party may be suspicious, while the PGG provides the methods the embodiment uses to further refine that belief. In addition to plans, goals and concepts, important parts of the knowledge base are: 1) monitors, which track the state of the embodiment and activate when certain conditions are true; and 2) methods, which accomplish various tasks such as querying databases. The two outcomes described in the CNG shown are “Detain Vehicle” 301 and “Subject should be detained” 302.

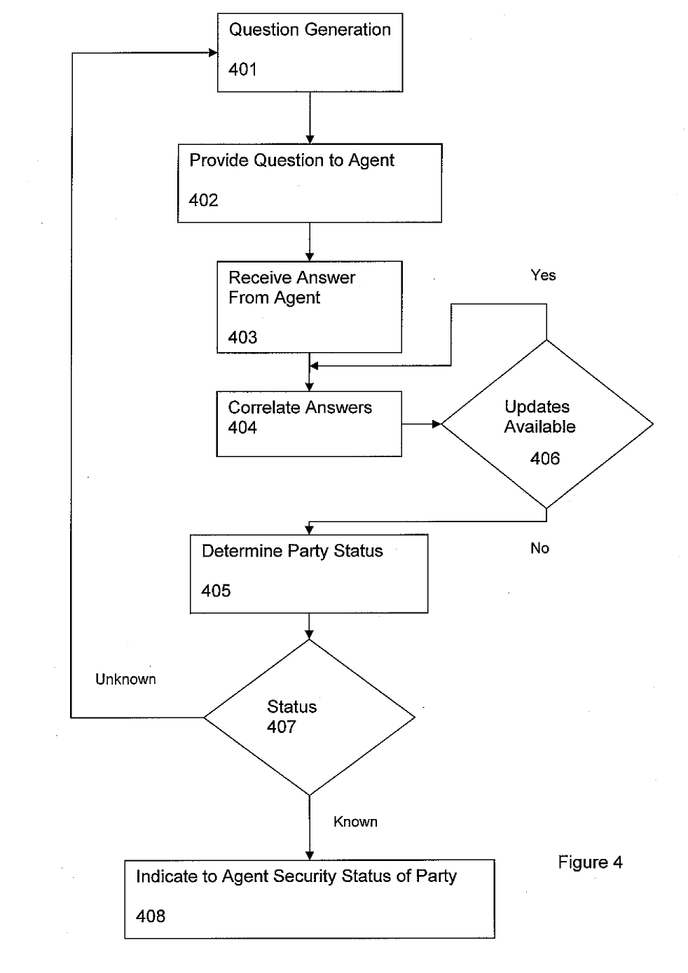

FIG. 4 depicts a flowchart view of selected operations used in accordance with various embodiments of the present disclosure. In this embodiment the Computing Environment 105 would communicate with the agent at the Checkpoint with an output and input device which may comprise a handheld computer device with keyboard and GUI (Graphical User Interface) output device to relay instructions and information to the agent and accept inputs from the agent. In this embodiment the Computing Environment 105 would generate one or more questions, 401 regarding a party attempting to cross the checkpoint. The question(s) may be generated using data available to the Computing Environment 105 whether the Computing Environment 105 is functioning in the networked mode or the stand-alone mode.

The question generation may draw on all information available to the Computing Environment at that instant. The questions may be generated using intelligent systems that may involve artificial intelligence, predictive analysis, inductive reasoning, Bayesian reasoning, iterative methods, or probability calculations. Once the question(s) has (have) been generated it is (they are) provided to the agent, 402 by communicating via the output device of the Computing Environment 105, in this embodiment using the GUI output device of the handheld computing device.

In another embodiment the agent may be an automated robotic device or autonomous agent that the question is communicated to. The agent then proceeds to interrogate the party with the question(s), and once the responsive answer(s) is (are) received from the party, the agent communicates the answer(s) back to the Computing Environment 105 using an input device, in this embodiment the keyboard of the handheld computing device, allowing the Computing Environment 105 to Receive the Answer from the Agent, 403. The Computing Environment 105 may then Correlate the Answers, 404, from the party with information available to the Computing Environment 105 depending in which mode the computing device is functioning, which could be stand-alone mode or network mode; where the network mode may include being connected to a central server or to other checkpoints or a combination of both.

The correlating function may be comprised of intelligent systems that may include artificial intelligence, predictive analysis, inductive reasoning, Bayesian reasoning, iterative methods, or probability calculations. If updates are available, 406 the Computing Environment 105 may check for available updates and continue to correlate using the additional updates. In this embodiment the Computing Environment 105 constantly attempts to use the most up-to-date information available.

On completion of the correlating the Computing Environment proceeds to Determine the Party's Status, 405. In this embodiment it is either known or unknown, 407. If the status of the party is unknown, the operations are repeated from Question Generation, 401, using the newly acquired data and the available data, to continue the operations. If the status is known, 407, the Computing Environment Indicates to the Agent, Security Status of the Party, 408. In this embodiment this is carried out by the GUI of the handheld device. The status may include safe, potentially hostile, terrorist, criminal or smuggling, and whether to detain or contain. Once the status is relayed to the Agent at the checkpoint, the checkpoint personnel can carry out the appropriate action regarding the party.

FIG. 5 depicts an example of a computing device capable of performing the operations of various embodiments of the present disclosure. As shown, computing system/device 500 may include one or more processors 502, and system memory 504. Additionally, computing system/device 500 may include one or more selectively removable data storage devices 506 (such as diskette, hard drive, CDROM, solid-state memory, thumb drive, and so forth), input/output devices 508 (such as keyboard, cursor control and so forth) and communication interfaces 510 (such as network interface cards, modems and so forth). The elements may be coupled to each other via system bus 512, which represents one or more buses. In the case of multiple buses, they may be bridged by one or more bus bridges (not shown).

System memory 504 and mass storage 506 may be employed to store a working copy and a permanent copy of the programming instructions implementing one or more aspects of the above described teachings to practice the security methods and apparatuses of the present disclosure, such as computational logic 514. The programming instructions may be implemented in assembler instructions supported by processor(s) 502, interpreted scripts/code, or high level languages, such as C, that may be compiled into such instructions. The permanent copy of the programming instructions may be placed into permanent storage 506 in the factory, or in the field, through, e.g., a distribution medium (not shown) or through communication interface 510 (from a distribution server (not shown)).

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present disclosure. Those with skill in the art will readily appreciate that the present disclosure may be implemented in a very wide variety of embodiments. This application is intended to cover any adaptations or variations of the embodiments discussed herein. Therefore, it is manifestly intended that this disclosure be limited only by the claims and the equivalents thereof.

What is claimed is:

1. A method comprising:
receiving, by a computing environment, one or more answers to one or more questions from an agent at a security checkpoint where the agent is interrogating a party, the questions being provided to the agent in real time, and the answers being obtained from the party;
dynamically correlating in real time, by the computer environment, the one or more received answers to said one or more questions with either or both of real time data and/or stored security data;
determining in real time, by the computer environment, a security status of the party based on results of said correlating; and
indicating by the computer environment, or causing to be indicated to the agent in real time, the determined security status of the party.

2. The method of claim 1, further comprising providing by the computing environment, the one or more questions to the agent.

3. The method of claim 2, further comprising generating by the computing environment, at least a subset of the one or more questions in real time just prior to their provision.

4. The method of claim 2, further comprising repeating said providing, said receiving and said correlating, until said determining is successful.

5. The method of claim 1, further comprising a mobile device of the computer environment making a connection to a server via a network fabric, the mobile device being used by the agent and working in a networked mode, said receiving, correlating, determining, and indicating being performed by the mobile device in real time, said indicating comprising the mobile device providing the determined status to the agent, and the method further comprising the mobile device receiving continuous updates to either or both of said real time data and said stored security data.

6. The method of claim 1, further comprising a mobile device of the computing environment accepting a connection from a server of the computer environment via a network fabric, the mobile device being used by the agent and working in a stand-alone mode prior to making the connection, which is one of a plurality of periodic connections, said receiving, correlating, determining, and indicating being performed by the mobile device in real time, said indicating comprising the mobile device providing the determined status to the agent, and the method further comprising the mobile device receiving batch updates to either or both of said real time data and said stored security data.

7. The method of claim 6, wherein said correlating comprises re performing the correlating by the mobile device is responsive to the mobile device receiving said updates after making the connection with the server of the computing environment.

8. The method of claim 1, wherein the status is a selected one from the set consisting of:
safe, potentially hostile, terrorist, criminal or smuggling, and whether to detain or contain.

9. The method of claim 1, wherein said determining is performed based on one or more of:
historical data, trend data, or current data from one or more other security checkpoints.

10. The method of claim 1, wherein said determining comprises performing at least one from the set consisting of:
artificial intelligence, predictive analysis, inductive reasoning, Bayesian reasoning, iterative methods, or probability calculations.

11. The method of claim 1, where said correlating comprises correlating with data collected from other security checkpoints in real time.

12. The method of claim 1, where the security checkpoint is located at a selected one of a border crossing, an airport, a port of entry, a container terminal, or a road block checkpoint.

13. The method of claim 1, further comprising generating the questions by using at least one from the set consisting of:
artificial intelligence, question databases, predictive analysis, inductive reasoning, Bayesian reasoning, iterative methods, or probability analysis.

14. The method of claim 1, where the answers are provided by the computer environment through a GUI on a mobile device used by the agent, the mobile device communicatively coupled with a server of the computer environment.

15. The method of claim 1, where said determining of the security status is further based on an algorithmic expression referencing at least one of suspicion, means, motive, or opportunity.

16. An apparatus comprising:
a processor; and
logic operated by the processor and adapted to
receive in real time one or more answers to one or more questions from an agent at a security checkpoint where the agent is interrogating a party, the questions being provided to the agent in real time, and the answers being obtained from the party;
dynamically correlate, the one or more received answers to said one or more questions with either or both of real time data and/or stored security data;
determine, a security status of the party based on results of said correlation; and
indicate, or cause to indicate to the agent the determined security status of the party.

17. The apparatus of claim 16, wherein the logic is further adapted to:
provide one or more questions to the agent, at least a subset of the one or more questions are generated in real time, and the questions are provided until a status is obtained.

18. The apparatus of claim 16, wherein the logic is further adapted to be located at a checkpoint, border crossing, airport, port of entry or cargo crossing.

19. The apparatus of claim 16, wherein the logic is further adapted to correlate data with data collected from other security checkpoints in real time.

20. An article of manufacture comprising:
a storage medium; and
a plurality of programming instructions stored on the storage medium and configured to program an apparatus to:
receive in real time one or more answers to one or more questions from an agent at a security checkpoint where the agent is interrogating a party, the questions being provided to the agent in real time, and the answers being obtained from the party;
correlate dynamically, the one or more received answers to said one or more questions with either or both of real time data and/or stored security data;
determine, a security status of the party based on results of said correlation; and
indicate, or cause to indicate to the security checkpoint the determined security status of the party.

21. The article of claim 20, wherein the programming instructions are further configured to program the apparatus to:
provide one or more questions to the security checkpoint agent, at least a subset of the one or more questions are generated in real time, and the questions are provided until a status is obtained.

22. The article of claim 20, can be located at a checkpoint, border crossing, airport, port of entry or cargo crossing.
